(19) United States
(12) Patent Application Publication
(10) Pub. No.: US 2010/0068592 A1
(43) Pub. Date: Mar. 18, 2010

(54) Electrodes for use in hydrocarbon-based membrane electrode assemblies of direct oxidation fuel cells

(75) Inventors: Takashi Akiyama, Osaka (JP); Xinhuai Ye, State College, PA (US); Chao-Yang Wang, State College, PA (US)

Correspondence Address: MCDERMOTT WILL & EMERY LLP, 600 13TH STREET, N.W., WASHINGTON, DC, 20005-3096, US

(73) Assignees: MATSUSHITA ELECTRIC INDUSTRIAL CO., LTD.; THE PENN STATE RESEARCH FOUNDATION

(21) Appl. No.: 11/889,105

(22) Filed: Aug. 9, 2007

(51) Int. Cl. H01M 8/10; H01M 4/00; H01M 4/88

(52) U.S. Cl. 429/33; 429/40; 502/101; 429/42; 429/30

(57) ABSTRACT

Electrodes for use in direct oxidation fuel cells (DOFCs) comprise, in sequence: an electrically conductive gas diffusion layer; a catalyst layer; and a proton-conducting layer. Membrane electrode assemblies (MEAs) comprise cathode and anode electrodes of such type sandwiching a proton conductive polymer electrolyte membrane (PEM), with the proton-conducting layer of the electrodes in contact with opposite surfaces of the PEM. Also disclosed is a method for fabricating the MEAs.

### FIELD OF THE DISCLOSURE

The present disclosure relates generally to fuel cells, fuel cell systems, and electrodes for use in membrane electrode assemblies of same. More specifically, the present disclosure relates to electrodes for use in membrane electrode assemblies comprising hydrocarbon-based polymer electrolyte membranes for direct oxidation fuel cells, such as direct methanol fuel cells, and their method of fabrication.

### BACKGROUND OF THE DISCLOSURE

A direct oxidation fuel cell (hereinafter “DOFC”) is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol (“MeOH”), formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a direct methanol fuel cell (hereinafter “DMFC”). A DMFC generally employs a membrane-electrode assembly (hereinafter “MEA”) having an anode, a cathode, and a proton-conducting polymer electrolyte membrane (hereinafter “PEM”) positioned therebetween. A typical example of a PEM is one composed of a perfluorosulfonic acid-tetrafluorethylene copolymer having a hydrophobic fluorocarbon backbone and perfluoroether side chains containing a strongly hydrophilic pendant sulfonic acid group (SO₃H), such as Nafion® (Nafion® is a registered trademark of E.I. Dupont de Nemours and Company). When exposed to H₂O, the hydrolyzed form of the sulfonic acid group (SO₃⁻H₃O⁺) allows for effective proton (H⁺) transport across the membrane, while providing thermal, chemical, and oxidative stability. In a DMFC, a methanol/water solution is directly supplied to the anode as the fuel and air is supplied to the cathode as the oxidant. At the anode, the methanol reacts with the water in the presence of a catalyst, typically a Pt or Ru metal-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DMFC, the protons migrate to the cathode through the proton-conducting membrane electrolyte, which is non-conductive to electrons. The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+3/2O₂→CO₂+2H₂O (3)

The ability to use highly concentrated fuel is desirable for portable power sources, particularly since DMFC technology is currently competing with advanced batteries, such as those based upon lithium-ion technology.

In order to utilize highly concentrated fuel with DOFC systems, such as DMFC systems described above, it is necessary to reduce the oxidant stoichiometry ratio, i.e., flow of oxidant (air) to the cathode for reaction according to equation (2) above. In turn, operation of the cathode must be optimized so that liquid product(s), e.g., water, formed on or in the vicinity of the cathode can be removed therefrom without resulting in substantial flooding of the cathode.

Notwithstanding the above-described advantageous characteristics of perfluorosulfonic acid-tetrafluorethylene copolymers (e.g., Nafion®) when utilized as a PEM in DOFCs, a drawback of conventional DMFCs utilizing same as a PEM is that the methanol (CH₃OH) partly permeates the PEM from the anode to the cathode, such permeated methanol being termed “crossover methanol”. The crossover methanol chemically (i.e., not electrochemically) reacts with oxygen at the cathode, causing a reduction in fuel utilization efficiency and cathode potential, with a corresponding reduction in power generation of the fuel cell. It is thus conventional for DMFC systems to use excessively dilute (3-6% by vol.) methanol solutions for the anode reaction in order to limit methanol crossover and its detrimental consequences. However, a problem with such a DMFC system is that it requires a significant amount of water to be carried in a portable system, thus diminishing the system energy density.

In view of the foregoing, it is considered desirable for the PEMs of DMFCs to have high proton (i.e., H⁺) conductivity and low methanol crossover rate. Disadvantageously however, currently available, state of the art perfluorinated PEMs have relatively high methanol crossover rates which adversely affect fuel cell performance due to cathode mixed potentials and low fuel efficiency. As a consequence, much research effort has focused on developing alternative PEMs having lower methanol crossover rates along with minimum reduction in proton conductivity. In this regard, hydrocarbon-based PEMs have evidenced promise in attaining these attributes, and several hydrocarbon-based PEMs have demonstrated low methanol crossover rates and other favorable attributes, such as excellent chemical and mechanical stability. See, for example, the pore-filled hydrocarbon-based PEMs disclosed by T. Yamaguchi et al. in Electrochemistry Communications, 7, pp. 730-734 (2005) and J. Membrane Science, 214, pp. 283-292 (2003). However, the relatively low proton conductivity and high membrane resistance of hydrocarbon-based PEMs generally limits obtainment of high power densities. In addition, hydrocarbon-based PEMs are incompatible with ionomer bonded electrodes using Nafion®, and give rise to high interfacial resistance between the membrane and electrode. Furthermore, difficulty occurs in transferring the catalyst layer onto the membrane via the commonly utilized decal hot-pressing procedure. Specifically, failures due to membrane-electrode delamination and significant increase in cell resistance have been observed when dissimilar PEMs are utilized with conventional Nafion®-bonded electrodes via commonly employed decal hot pressing or coating procedures.

In view of the foregoing, there exists a clear need for improved electrodes for MEAs based on hydrocarbon membranes and DOFC/DMFC systems, as well as methodologies for fabricating same.

### SUMMARY OF THE DISCLOSURE

Advantages of the present disclosure include improved electrodes for membrane electrode assemblies (MEAs) and their fabrication method.

Another advantage of the present disclosure is improved DOFCs and DMFCs including MEAs comprising the improved electrodes and MEAs provided by the present disclosure.

Additional advantages and features of the present disclosure will be set forth in the disclosure which follows and in part will become apparent to those having ordinary skill in the art upon examination of the following or may be learned from the practice of the present disclosure. The advantages may be realized and obtained as particularly pointed out in the appended claims.

According to an aspect of the present disclosure, the foregoing and other advantages are achieved in part by an electrode for use in a membrane electrode assembly (MEA), comprising in sequence:

(a) an electrically conductive gas diffusion layer (GDL);

(b) a catalyst layer; and

(c) a proton-conducting layer.

According to preferred embodiments of the present disclosure, the proton-conducting layer is from about 0.1 to about 5 μm thick and comprises at least one ionomer. The at least one ionomer can be selected from among the group consisting of: fluorinated ionomers, sulfonated polystyrene ionomers, sulfonated poly (ether ketone ketone) ionomers, sulfonated polyimide ionomers, and sulfonated poly (arylene ether sulfone) ionomers. The ionomer is preferably is a fluorinated ionomer. The electrically conductive GDL may comprise a porous carbon-based material and a support material.

In accordance with embodiments of the present disclosure, when the catalyst layer is adapted for performing an electrochemical oxidation reaction the electrode is an anode electrode; and when the catalyst layer is adapted for performing an electrochemical reduction reaction, the electrode is a cathode electrode.

According to embodiments of the present disclosure, the electrode can further comprise:

(d) a hydrophobic, micro-porous layer (MPL) intermediate the GDL and the catalyst layer, wherein the MPL comprises a porous, electrically conductive material and a hydrophobic material.

Another aspect of the present disclosure is a membrane electrode assembly (MEA), comprising:

(a) a proton-conducting polymeric electrolyte membrane (PEM) having oppositely facing first and second surfaces;

(b) an anode electrode adjacent the first surface, the anode electrode comprising a catalyst layer; and

(c) a cathode electrode adjacent the second surface, the cathode electrode comprising a catalyst layer; wherein the MEA further comprises:

(d) a proton-conducting layer intermediate at least one of the catalyst layers and the PEM.

Preferably, a proton-conducting layer is intermediate each of the catalyst layers and the PEM, is from about 0.1 to about 5 μm thick, and comprises at least one ionomer, preferably at least one fluorinated ionomer selected from the group consisting of: fluorinated ionomers, sulfonated polystyrene ionomers, sulfonated poly (ether ketone ketone) ionomers, sulfonated polyimide ionomers, and sulfonated poly (arylene ether sulfone) ionomers; the PEM is from about 25 to about 200 μm thick and comprises a sheet of hydrocarbon-based polymeric material, such as sulfonated poly (ether ether ketone) (“SPEEK”), sulfonated poly-(ether ether ketone ketone) (“SPEEKK”), sulfonated poly (arylene ether sulfone) (“SPES”), sulfonated poly (arylene ether benzonitrile), sulfonated polyimides (“SPI”s), sulfonated polystyrene, and sulfonated poly (styrene-b-isobutylene-b-styrene) (“S-SIBS”).

Still other aspects of the present disclosure are improved direct oxidation fuel cells (DOFCs) comprising a MEA as described above, as well as direct methanol (MeOH) fuel cell (DMFC) systems comprising the improve DOFC and a source of MeOH fuel.

A further aspect of the present disclosure is an improved method of fabricating a membrane electrode assembly (MEA), comprising steps of:

(a) forming a proton-conducting layer on a catalyst layer of at least one of a cathode electrode and an anode electrode; and

(b) placing a polymer electrolyte membrane (PEM) between the cathode and anode electrodes with the at least one proton-conducting layer in contact with the PEM.

Preferably, step (a) comprises forming a proton-conducting layer on each of the catalyst layers; and step (b) comprises placing the PEM between the cathode and anode electrodes with the proton-conducting layers in contact with oppositely facing surfaces of the PEM; wherein step (b) comprises forming a proton-conducting layer comprising at least one ionomer, preferably at least one fluorinated ionomer selected from the group consisting of: fluorinated ionomers, sulfonated polystyrene ionomers, sulfonated poly (ether ketone ketone) ionomers, sulfonated polyimide ionomers, and sulfonated poly (arylene ether sulfone) ionomers; and step (b) comprises providing a PEM comprising a hydrocarbon-based polymeric material selected from the group consisting of: sulfonated poly (ether ether ketone) (“SPEEK”), sulfonated poly-(ether ether ketone ketone) (“SPEEKK”), sulfonated poly (arylene ether sulfone) (“SPES”), sulfonated poly (arylene ether benzonitrile), sulfonated polyimides (“SPI”s), sulfonated polystyrene, and sulfonated poly (styrene-b-isobutylene-b-styrene) (“S-SIBS”).

Additional advantages of the present disclosure will become readily apparent to those skilled in this art from the following detailed description, wherein only the preferred embodiments of the present disclosure are shown and described, simply by way of illustration of the best mode contemplated for practicing the present disclosure. As will be realized, the disclosure is capable of other and different embodiments, and its several details are capable of modification in various obvious respects, all without departing from the spirit of the present invention. Accordingly, the drawings and description are to be regarded as illustrative in nature, and not as restrictive.

### BRIEF DESCRIPTION OF THE DRAWINGS

The various features and advantages of the present disclosure will become more apparent and facilitated by reference to the accompanying drawings, provided for purposes of illustration only and not to limit the scope of the invention, wherein the same reference numerals are employed throughout for designating like features and the various features are not necessarily drawn to scale but rather are drawn as to best illustrate the pertinent features, wherein:

FIG. 1 is a simplified, schematic illustration of a DOFC system capable of operating with highly concentrated methanol fuel, i.e., a DMFC system;

FIG. 2 is a schematic, cross-sectional view of a representative configuration of a MEA suitable for use in a fuel cell/fuel cell system such as the DOFC/DMFC system of FIG. 1;

FIG. 3 is a graph for comparing the steady state electrical performance of DMFCs comprising MEAs with (A1) and without (R1) thin proton conductive layers and an about 62 μm thick hydrocarbon-based PEM, operating at a current density of 200 mA/cm² at 60° C. with 2M MeOH; and

FIG. 4 is a graph for comparing the steady state electrical performance of DMFCs comprising MEAs with (A2) and without (R2) thin proton conductive layers and an about 30 μm thick pore-filled hydrocarbon-based PEM, operating at a current density of 200 mA/cm² at 60° C. with 2M MeOH.

### DETAILED DESCRIPTION OF THE DISCLOSURE

The present disclosure relates to fuel cells and fuel cell systems with high power conversion efficiency, such as DOFC's and DOFC systems operating with highly concentrated fuel, e.g., DMFC's and DMFC systems fueled with about 2 to about 25 M MeOH solutions. The present disclosure further relates to improved PEMs for use in electrodes/electrode assemblies therefor, and to methodology for fabricating same.

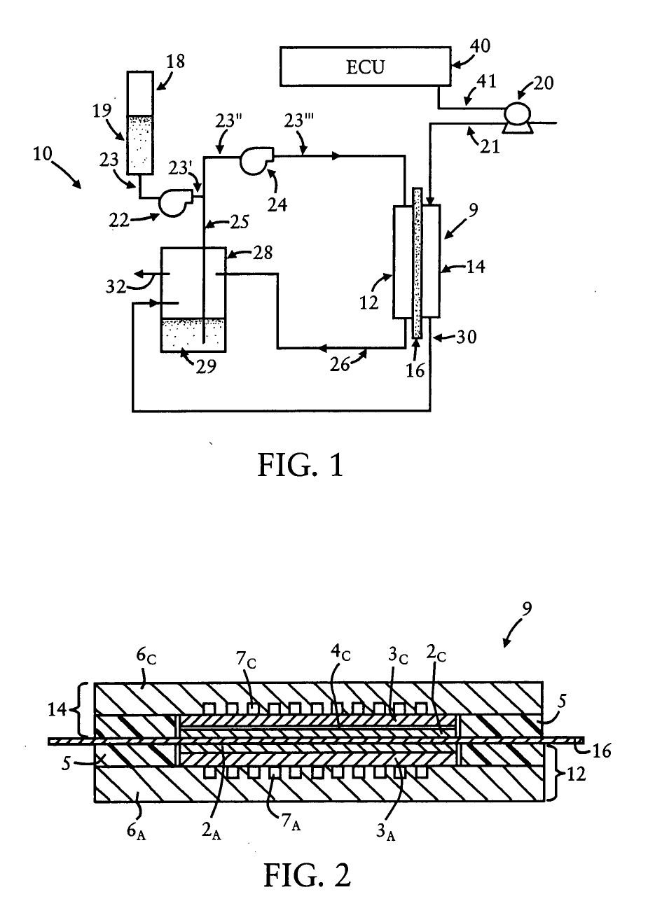

Referring to FIG. 1, schematically shown therein is an illustrative embodiment of a DOFC system adapted for operating with highly concentrated fuel, e.g., a DMFC system 10, which system maintains a balance of water in the fuel cell and returns a sufficient amount of water from the cathode to the anode under high-power and elevated temperature operating conditions. (A DOFC/DMFC system is disclosed in a co-pending application filed Dec. 27, 2004, published Jun. 29, 2006 as U.S. Patent Publication US 2006-0141338 A1).

As shown in FIG. 1, DMFC system 10 includes an anode 12, a cathode 14, and a proton-conducting PEM 16, forming a multi-layered composite membrane-electrode assembly or structure 9 commonly referred to as an MEA. Typically, a fuel cell system such as DMFC system 10 will have a plurality of such MEA's in the form of a stack; however, FIG. 1 shows only a single MEA 9 for illustrative simplicity. Frequently, the MEA's 9 are separated by bipolar plates that have serpentine channels for supplying and returning fuel and by-products to and from the assemblies (not shown for illustrative convenience). In a fuel cell stack, MEAs and bipolar plates are aligned in alternating layers to form a stack of cells and the ends of the stack are sandwiched with current collector plates and electrical insulation plates, and the entire unit is secured with fastening structures. Also not shown in FIG. 1, for illustrative simplicity, is a load circuit electrically connected to the anode 12 and cathode 14.

A source of fuel, e.g., a fuel container or cartridge 18 containing a highly concentrated fuel 19 (e.g., methanol), is in fluid communication with anode 12 (as explained below). An oxidant, e.g., air supplied by fan 20 and associated conduit 21, is in fluid communication with cathode 14. The highly concentrated fuel from fuel cartridge 18 is fed directly into liquid/gas (hereinafter “L/G”) separator 28 by pump 22 via associated conduit segments 23′ and 25, or directly to anode 12 via pumps 22 and 24 and associated conduit segments 23, 23′, 23″, and 23′″.

In operation, highly concentrated fuel 19 is introduced to the anode side of the MEA 9, or in the case of a cell stack, to an inlet manifold of an anode separator of the stack. Water produced at the cathode 14 side of MEA 9 or cathode cell stack via electrochemical reaction (as expressed by equation (2)) is withdrawn therefrom via cathode outlet or exit port/conduit 30 and supplied to L/G separator 28. Similarly, excess fuel (MeOH), H₂O, and CO₂ gas are withdrawn from the anode side of the MEA 9 or anode cell stack via anode outlet or exit port/conduit 26 and supplied to L/G separator 28. The air or oxygen is introduced to the cathode side of the MEA 9 and regulated to maximize the amount of electrochemically produced water in liquid form while minimizing the amount of electrochemically produced water vapor, thereby minimizing the escape of water vapor from system 10.

During operation of system 10, air is introduced to the cathode 14 (as explained above) and excess air and liquid water are withdrawn therefrom via cathode exit port/conduit 30 and supplied to L/G separator 28. As discussed further below, the input air flow rate or air stoichiometry is controlled to maximize the amount of the liquid phase of the electrochemically produced water while minimizing the amount of the vapor phase of the electrochemically produced water. Control of the oxidant stoichiometry ratio can be obtained by setting the speed of fan 20 at a rate depending on the fuel cell system operating conditions or by an electronic control unit (hereinafter “ECU”) 40, e.g., a digital computer-based controller or equivalently performing structure. ECU 40 receives an input signal from a temperature sensor in contact with the liquid phase 29 of L/G separator 28 (not shown in the drawing for illustrative simplicity) and adjusts the oxidant stoichiometry ratio (via line 41 connected to oxidant supply fan 20) to maximize the liquid water phase in the cathode exhaust and minimize the water vapor phase in the exhaust, thereby reducing or obviating the need for a water condenser to condense water vapor produced and exhausted from the cathode of the MEA 2. In addition, ECU 40 can increase the oxidant stoichiometry beyond the minimum setting during cold-start in order to avoid excessive water accumulation in the fuel cell.

Liquid water 29 which accumulates in the L/G separator 28 during operation may be returned to anode 12 via circulating pump 24 and conduit segments 25, 23″, and 23′″. Exhaust carbon dioxide gas is released through port 32 of L/G separator 28.

As indicated above, cathode exhaust water, i.e., water which is electrochemically produced at the cathode during operation, is partitioned into liquid and gas phases, and the relative amounts of water in each phase are controlled mainly by temperature and air flow rate. The amount of liquid water can be maximized and the amount of water vapor minimized by using a sufficiently small oxidant flow rate or oxidant stoichiometry. As a consequence, liquid water from the cathode exhaust can be automatically trapped within the system, i.e., an external condenser is not required, and the liquid water can be combined in sufficient quantity with a highly concentrated fuel, e.g., greater than about 5 M solution, for use in performing the anodic electrochemical reaction, thereby maximizing the concentration of fuel and storage capacity and minimizing the overall size of the system. The water can be recovered in any suitable existing type of L/G separator 28, e.g., such as those typically used to separate carbon dioxide gas and aqueous methanol solution.

The DOFC/DMFC system 10 shown in FIG. 1 comprises at least one MEA 9 which includes a PEM 16 and a pair of electrodes (an anode 12 and a cathode 14) each composed of a catalyst layer and a gas diffusion layer sandwiching the membrane. Typical PEM materials include fluorinated polymers having perfluorosulfonate groups (as described above) or hydrocarbon polymers, e.g., poly-(arylene ether ether ketone) (hereinafter “PEEK”). The PEM can be of any suitable thickness as, for example, between about 25 and about 200 μm. The catalyst layer typically comprises platinum (Pt) or ruthenium (Ru) based metals, or alloys thereof. The anodes and cathodes are typically sandwiched by bipolar separator plates having channels to supply fuel to the anode and an oxidant to the cathode. A fuel cell stack can contain a plurality of such MEA's 9 with at least one electrically conductive separator placed between adjacent MEA's to electrically connect the MEA's in series with each other, and to provide mechanical support.

As indicated above, ECU 40 can adjust the oxidant flow rate or stoichiometric ratio to maximize the liquid water phase in the cathode exhaust and minimize the water vapor phase in the exhaust, thereby eliminating the need for a water condenser. ECU 40 adjusts the oxidant flow rate, and hence the stoichiometric ratio, according to equation (4) given below:

$${ξ}_{c} = \frac{0.42 ( γ + 2 )}{3 {η}_{fuel}} \frac{p}{{p}_{sat}} \qquad ( 4 )$$

wherein ξ_{c} is the oxidant stoichiometry, γ is the ratio of water to fuel in the fuel supply, pₛₐₜ is the water vapor saturation pressure corresponding to the cell temperature, p is the cathode operating pressure, and η_{fuel} is the fuel efficiency, defined as the ratio of the operating current density, I, to the sum of the operating current density and the equivalent fuel (e.g., methanol) crossover current density, Iₓₒᵥₑᵣ, as expressed by equation (5) below:

$${η}_{fuel} = \frac{I}{I + {I}_{xover}} \qquad ( 5 )$$

Such controlled oxidant stoichiometry automatically ensures an appropriate water balance in the DMFC (i.e. enough water for the anode reaction) under any operating conditions. For instance, during start-up of a DMFC system, when the cell temperature increases from e.g., 20° C. to the operating point of 60° C., the corresponding pₛₐₜ is initially low, and hence a large oxidant stoichiometry (flow rate) should be used in order to avoid excessive water accumulation in the system and therefore cell flooding by liquid water. As the cell temperature increases, the oxidant stoichiometry (e.g., air flow rate) can be reduced according to equation (4).

In the above, it is assumed, though not required, that the amount of liquid (e.g., water) produced by electrochemical reaction in MEA 9 and supplied to L/G separator 28 is essentially constant, whereby the amount of liquid product returned to the inlet of anode 12 via pump 24 and conduit segments 25, 23″, and 23′″ is essentially constant, and is mixed with concentrated liquid fuel 19 from fuel container or cartridge 18 in an appropriate ratio for supplying anode 12 with fuel at an ideal concentration.

Referring now to FIG. 2, shown therein is a schematic, cross-sectional view of a representative configuration of a MEA 9 for illustrating its various constituent elements in more detail. As illustrated, a cathode electrode 14 and an anode electrode 12 sandwich a PEM 16 made of a material, such as described above, adapted for transporting hydrogen ions from the anode to the cathode during operation. The anode electrode 12 comprises, in order from PEM 16, a metal-based catalyst layer 2_{A} in contact therewith, and an overlying gas diffusion layer (hereinafter “GDL”) 3_{A}, whereas the cathode electrode 14 comprises, in order from electrolyte membrane 16: (1) a metal-based catalyst layer 2_{C} in contact therewith; (2) an intermediate, hydrophobic micro-porous layer (hereinafter “MPL”) 4_{C}; and (3) an overlying gas diffusion medium (hereinafter “GDM”) 3_{C}. GDL 3_{A} and GDM 3_{C} are each gas permeable and electrically conductive, and may be comprised of a porous carbon-based material including a carbon powder and a fluorinated resin, with a support made of a material such as, for example, carbon paper or woven or non-woven cloth, felt, etc. Metal-based catalyst layers 2_{A} and 2_{C} may, for example, comprise Pt or Ru. MPL 4_{C} may be formed of a composite material comprising an electrically conductive powder such as carbon black and a hydrophobic material such as PTFE.

Completing MEA 9 are respective electrically conductive anode and cathode separators 6_{A} and 6_{C} for mechanically securing the anode 12 and cathode 14 electrodes against PEM 16. As illustrated, each of the anode and cathode separators 6_{A} and 6_{C} includes respective channels 7_{A} and 7_{C} for supplying reactants to the anode and cathode electrodes and for removing excess reactants and liquid and gaseous products formed by the electrochemical reactions. Lastly, MEA 9 is provided with gaskets 5 around the edges of the cathode and anode electrodes for preventing leaking of fuel and oxidant to the exterior of the assembly. Gaskets 5 are typically made of an O-ring, a rubber sheet, or a composite sheet comprised of elastomeric and rigid polymer materials.

As indicated above, a drawback of a conventional DMFC is that the methanol (CH₃OH) fuel partly permeates the PEM 16 of MEA 9 from the anode 12 to the cathode 14, such permeated methanol being termed “crossover methanol”. The crossover methanol chemically (i.e., not electrochemically) reacts with oxygen at the cathode 12, causing a reduction in fuel utilization efficiency and cathode potential, with a corresponding reduction in power generation of the fuel cell.

As a consequence of the foregoing, it is considered desirable for the PEMs of DMFCs to have high proton (i.e., H⁺) conductivity and low methanol crossover rate. Disadvantageously however, currently available, state of the art perfluorinated electrolyte membranes have relatively high methanol crossover rates which adversely affect fuel cell performance due to cathode mixed potentials and low fuel efficiency. Much research effort has therefore focused on developing alternative PEMs having lower methanol crossover rates along with minimum reduction in proton conductivity. In this regard, hydrocarbon-based PEMs have evidenced promise in attaining these attributes, and several hydrocarbon-based PEMs have demonstrated low methanol crossover rates as well as other favorable attributes, such as excellent chemical and mechanical stability. However, their relatively low proton conductivity and high membrane resistance limits obtainment of desirably high power densities. In addition, hydrocarbon-based PEMs are incompatible with ionomer bonded electrodes comprising perfluorosulfonic acid-tetrafluorethylene copolymers, such as Nafion®, and give rise to high interfacial resistance between the PEM and the electrodes. Furthermore, difficulty occurs in transferring the catalyst layer onto the PEM via commonly utilized decal hot-pressing procedures.

In this context, a method was developed in which operation of a DOFC/DMFC system utilizing highly concentrated fuel (e.g., MeOH) is necessarily performed at low cathode (i.e., O₂ or air) stoichiometry in order to maintain sufficient H₂O within the system (see, e.g., U.S. Patent Application Publication US 2006/0141338 A1). However, system performance usually decreases with reduction of cathode stoichiometry, due to insufficient O₂ supply to the cathode. In order to remedy this drawback, an improved cathode GDL was developed with high gas diffusivity and H₂O removal rates (co-pending, commonly assigned U.S. patent application Ser. No. 11/655,867, filed Jan. 22, 2007). It has been observed, however, that when a hydrocarbon-based PEM and low cathode stoichiometry GDL are combined to form a MEA, the fuel cell impedance at high frequency increases with duration of operation, implying that the hydrocarbon-based PEM loses H₂O uptake ability during operation, leading to low proton conductivity.

While the precise mechanism for the above described phenomenon is presently unclear, it nonetheless can be concluded that hydrocarbon PEMs have a greater tendency to lose water from surfaces than PEMs based upon perfluorosulfonic acid-tetrafluorethylene copolymers, such as Nafion®.

Accordingly, an aim of the present disclosure is development of electrodes for MEAs of DOFC/DMFCs which include improved electrodes specifically designed for use with PEMs, such that the MEAs exhibit both high power densities and low MeOH crossover rates. To achieve this aim, functions of the improved electrodes afforded by the present disclosure can include:

1. improved interfacial contact between the electrode(s) (cathode and/or anode) and hydrocarbon-based PEM such that electrical performance of the DOFC/DMFC system and its long term stability can be significantly improved; and

2. H₂O loss from the surface of the hydrocarbon-based PEM is suppressed, such that the stability of high frequency impedance during operation of the DOFC/DMFC system can be significantly improved.

According to the present disclosure, the stated limitations/drawbacks of hydrocarbon-based PEMs for DOFC/DMFC systems can be minimized by coating electrodes (i.e., cathodes and/or anodes) utilized in forming MEAs of DOFCs/DMFCs with a thin (i.e., from about 0.1 to about 0.5 μm thick) layer of a proton-conducting material prior to interfacial contact with the hydrocarbon-based PEM during formation of the MEA, thereby effecting a significant reduction in H₂O loss from the PEM. As used herein, the term “hydrocarbon-based membrane”, includes a variety of hydrocarbon-based polymeric materials, including, by way of illustration only, sulfonated poly (ether ether ketone) (“SPEEK”), sulfonated poly-(ether ether ketone ketone) (“SPEEKK”), sulfonated poly (arylene ether sulfone) (“SPES”), sulfonated poly (arylene ether benzonitrile), sulfonated polyimides (“SPI”s), sulfonated polystyrene, and sulfonated poly (styrene-b-isobutylene-b-styrene) (“S-SIBS”). In accordance with preferred embodiments of the present disclosure, the thin, proton-conducting layer is comprised of at least one ionomer, preferably a fluorinated iononomer such as a perfluorosulfonic acid-tetrafluorethylene copolymer. Other ionomers that can be used include sulfonated polystyrene ionomers, sulfonated poly (ether ketone ketone) ionomers, sulfonated polyimide ionomers, and sulfonated poly (arylene ether sulfone) ionomers. One such material is available from the E.I. DuPont de Nemours Co. under the trademark Nafion®.

Electrodes for use in MEAs of DOFC/DMFCs including a thin, proton-conducting layer comprised of at least one ionomer according to the present disclosure may be formed by several procedures. According to an illustrative, but non-limiting, embodiment contemplated by the present disclosure, a solution or dispersion of at least one perfluorosulfonic acid-tetrafluorethylene copolymer is sprayed on a catalyst layer of an electrode, e.g., metal-based catalyst layers 2_{C} and 2_{A} of cathode 14 and anode 12 described above in connection with the description of FIG. 2, or sprayed directly on the hydrocarbon-based PEM 16 prior to assembly of MEA 9. A feature of this process is simultaneous removal of the solvent of the solution or dispersion during spraying via heating or application of a vacuum.

According to another illustrative, but non-limiting, process contemplated by the present disclosure, a solution or dispersion of at least one perfluorosulfonic acid-tetrafluorethylene copolymer is sprayed or coated on the surface of a sheet of polymeric material (e.g., PTFE), followed by solvent removal therefrom via heating or application of a vacuum to form a thin layer. The thin layer can then be transferred via a decal-hot press method to the surface of the metal-based catalyst layers 2_{C} and 2_{A} of cathode 14 and anode 12 or the hydrocarbon-based PEM 16 prior to assembly of MEA 9.

MEAs comprising thin, proton-conducting layers fabricated according to the present disclosure can provide a number of distinct advantages/benefits over conventional MEAs with hydrocarbon-based PEMs utilized in DOFC/DMFCs, including:

1. improved bonding between hydrocarbon-based PEMs and cathode and/or anode electrode(s), thereby facilitating manufacture and improving reliability against delamination of the resultant MEAs;

2. improved MEA impedance at high frequency due to lower contact resistance between the PEM and catalyst layers;

3. improved H₂O retention by the hydrocarbon-based PEMs due to reduced removal of H₂O from the membrane surface, yielding increased membrane conductivity;

4. retention of low MeOH crossover rate characteristic of hydrocarbon-based PEMs; and

5. significantly higher achievable power densities with high MeOH feed concentrations, arising from a combination of the above enumerated advantages/benefits.

The advantages/benefits afforded by the present disclosure will now be demonstrated by reference to the following illustrative, but non-limiting, examples.

According to one example of the present disclosure, a pair of MEAs were prepared for demonstrating the effect of the presence of the thin, proton-conducting layer on DOFC/DMFC performance. In a first MEA, a thin, proton-conducting layer in the form of a thin Nafion® layer having a thickness of about 1 μm and formed by the spraying process described supra was produced on the surface of each of the metal-based catalyst layers 2_{C} and 2_{A} of cathode 14 and anode 12, respectively, prior to formation of the MEA, the resultant MEA given the designation A1. A reference MEA without the thin, proton-conducting Nafion® layers on the cathode and anode catalyst layers was also prepared for reference purposes and given the designation R1.

An about 62 μm thick hydrocarbon-based polymer electrolyte membrane (PEM) (Z1, supplied by Polyfuel Co., Mountain View, Calif.) was utilized in forming each of the MEAs. The MEAs were fabricated via a laminating process wherein the hydrocarbon-based PEM was placed in a hot-press apparatus, sandwiched between the cathode and anode catalyst layers (with and without the thin, proton-conducting Nafion® layers), the temperature and pressure of the hot-press apparatus being set at 150° C. and 100 kgf/cm². All other procedures and conditions for fabricating the MEAs were as set forth in co-pending, commonly assigned U.S. patent application Ser. No. 11/655,867, filed Jan. 22, 2007, the entire disclosure of which is incorporated herein by reference.

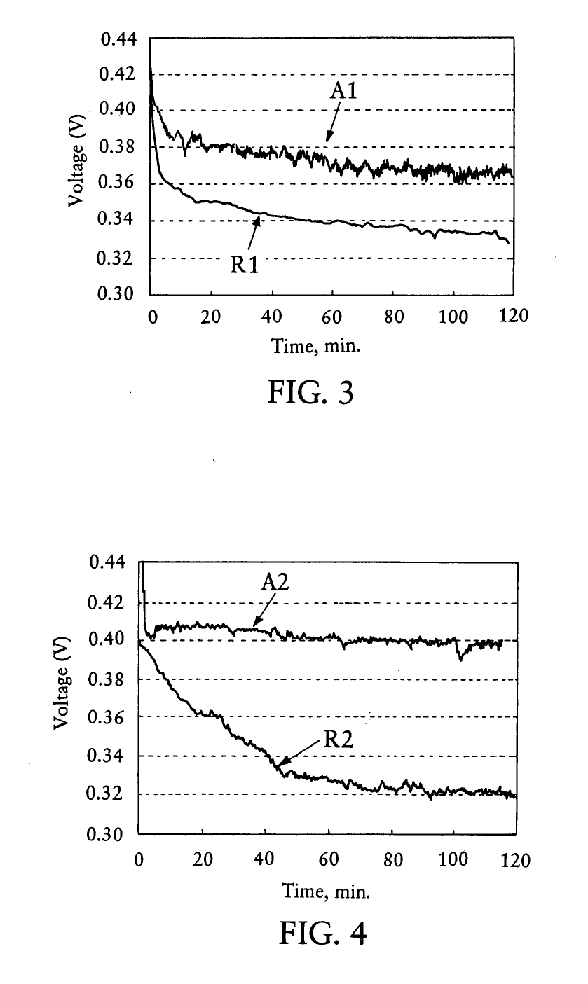

Referring now to FIG. 3, graphically shown therein is a comparison of the steady state electrical performance of DMFCs comprising MEAs with (A1) and without (R1) the thin, proton-conducting Nafion® layers, and the about 62 μm thick hydrocarbon-based PEM, operating at a current density of 200 mA/cm² at 60° C. with 2M MeOH. As is evident from FIG. 3, the decline in voltage during steady-state operation of the DMFC with the MEAs having thin, proton-conducting Nafion® layers (A1) is less than that of the DMFC with the MEAs not having thin, proton-conducting Nafion® layers (R1).

The high frequency AC impedance at 1 kHz of DMFC A1 and DMFC R1 was measured during the steady-state operation. Whereas the initial AC impedance of DMFC A1 was about 0.27 Ω-cm² and remained substantially constant during the about 2 hrs. operation interval, the initial AC impedance of DMFC R1 was about 0.33 Ω-cm² and it increased by about 10% in 1 hr., relative to its initial value. The reduced impedance of DMFC A1 vis-à-vis DMFC R1 indicates a reduction in contact resistance between the PEM and the cathode and anode catalyst layers provided by the thin, proton-conducting Nafion® layers formed on the cathode and anode layers prior to sandwiching of the PEM therebetween to form the MEAs. In addition, the improved stability of AC impedance provided by the thin, proton-conducting Nafion® layers during DMFC operation indicates advantageous reduction in H₂O loss from the PEM.

According to another example of the present disclosure, a pair of MEAs were prepared for demonstrating the effect of the presence of the thin, proton-conducting layer on DOFC/DMFC performance. In a first MEA, a thin, proton-conducting layer in the form of a thin Nafion® layer having a thickness of about 1 μm and formed by the spraying process described supra was produced on the surface of each of the metal-based catalyst layers 2_{C} and 2_{A} of cathode 14 and anode 12, respectively, prior to formation of the MEA. The resultant MEA was given the designation A2. A reference MEA without the thin, proton-conducting Nafion® layers on the cathode and anode catalyst layers was also formed as a reference and given the designation R2.

An about 30 μm thick pore-filled hydrocarbon-based polymer electrolyte membrane (PEM) was utilized in forming each of the MEAs. A MEA was then fabricated via a lamination process wherein the hydrocarbon-based PEM was placed in a hot-press apparatus, sandwiched between the cathode and anode catalyst layers (with and without the thin, proton-conducting Nafion® layers), the temperature and pressure of the hot-press apparatus being set at 125° C. and 100 kgf/cm². All other procedures and conditions for fabricating the MEAs were as set forth in co-pending, commonly assigned U.S. patent application Ser. No. 11/655,867, filed Jan. 22, 2007, the entire disclosure of which is incorporated herein by reference.

Referring now to FIG. 4, graphically shown therein is a comparison of the steady state electrical performance of DMFCs comprising MEAs with (A2) and without (R2) the thin, proton-conducting Nafion® layers and the about 30 μm thick hydrocarbon-based PEM, operating at a current density of 200 mA/cm² at 60° C. with 2M MeOH. As is evident from FIG. 4, the decline in voltage during steady-state operation of the DMFC with the MEAs having thin, proton-conducting Nafion® layers (A2) is less than that of the DMFC with the MEAs not having thin, proton-conducting Nafion® layers (R2).

The high frequency AC impedance at 1 kHz of DMFC A2 and DMFC R2 was measured during the steady-state operation. Whereas the initial AC impedance of DMFC A2 was about 0.26 Ω-cm² and remained substantially constant during the about 2 hrs. operation interval, the initial AC impedance of DMFC R2 was about 0.30 Ω-cm² and it increased by about 32% in 1 hr., relative to its initial value. The reduced impedance of DMFC A2 vis-à-vis DMFC R2 indicates a reduction in contact resistance between the PEM and the cathode and anode catalyst layers provided by the thin, proton-conducting Nafion® layers formed on the cathode and anode layers prior to sandwiching of the PEM therebetween to form the MEAs. In addition, the improved stability of AC impedance provided by the thin, proton-conducting Nafion® layers during DMFC operation indicates advantageous reduction in H₂O loss from the PEM.

In summary, the present disclosure provides ready fabrication of improved cathode and anode electrodes and MEAs for use in DOFCs such as DMFCs. The improved electrodes and MEAs afforded by the instant disclosure which include thin, proton-conductive ionomer layers intermediate the cathode and/or anode catalyst layers and hydrocarbon-based PEMs advantageously exhibit a desirable combination of properties, including improved bonding between the electrodes and the PEM, lower contact resistance between the electrodes and the PEM, improved H₂O retention by the PEM, low MeOH crossover, and high power densities at high fuel (e.g., MeOH) feed concentration, rendering them especially useful in high power density, high energy density DMFC applications. In addition, the methodology for fabricating the electrodes with thin, proton-conducting ionomer layers is simple and cost effective in mass production.

In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the disclosed concept as expressed herein.

What is claimed is:

1. An electrode for use in a membrane electrode assembly (MEA), comprising in the recited order:
(a) an electrically conductive gas diffusion layer (GDL);
(b) a catalyst layer; and
(c) a proton-conducting layer.

2. The electrode as in claim 1, wherein:
said proton-conducting layer comprises at least one ionomer.

3. The electrode as in claim 2, wherein:
said at least one ionomer is selected from the group consisting of: fluorinated ionomers, sulfonated polystyrene ionomers, sulfonated poly (ether ketone ketone) ionomers, sulfonated polyimide ionomers, and sulfonated poly (arylene ether sulfone) ionomers.

4. The electrode as in claim 1, wherein:
said proton-conducting layer is from about 0.1 to about 5 μm thick.

5. The electrode as in claim 1, wherein:
said electrically conductive GDL comprises a porous carbon-based material and a support material.

6. The electrode as in claim 1, wherein:
said catalyst layer is adapted for performing an electrochemical oxidation reaction and said electrode is an anode electrode.

7. The electrode as in claim 1, wherein:
said catalyst layer is adapted for performing an electrochemical reduction reaction and said electrode is a cathode electrode.

8. The electrode as in claim 7, further comprising:
(d) a hydrophobic, micro-porous layer (MPL) intermediate said GDL and said catalyst layer.

9. The electrode as in claim 8, wherein:
said MPL comprises a porous, electrically conductive material and a hydrophobic material.

10. A membrane electrode assembly (MEA), comprising:
(a) a proton-conducting polymeric electrolyte membrane (PEM) having oppositely facing first and second surfaces;
(b) an anode electrode adjacent said first surface, said anode electrode comprising a catalyst layer; and
(c) a cathode electrode adjacent said second surface, said cathode electrode comprising a catalyst layer; wherein said MEA further comprises:
(d) a proton-conducting layer intermediate at least one of said catalyst layers and said PEM.

11. The MEA as in claim 10, comprising:
a proton-conducting layer intermediate each of said catalyst layers and said PEM.

12. The MEA as in claim 10, wherein:
said proton-conducting layer comprises at least one ionomer.

13. The MEA as in claim 12, wherein:
said at least one ionomer is selected from the group consisting of: fluorinated ionomers, sulfonated polystyrene ionomers, sulfonated poly (ether ketone ketone) ionomers, sulfonated polyimide ionomers, and sulfonated poly (arylene ether sulfone) ionomers.

14. The MEA as in claim 12, wherein:
said proton-conducting layer is from about 0.1 to about 5 μm thick.

15. The MEA as in claim 10, wherein:
said PEM comprises a sheet of hydrocarbon-based polymeric material.

16. The MEA as in claim 15, wherein:
said hydrocarbon-based polymeric material is selected from the group consisting of: sulfonated poly (ether ether ketone) (“SPEEK”), sulfonated poly-(ether ether ketone ketone) (“SPEEKK”), sulfonated poly (arylene ether sulfone) (“SPES”), sulfonated poly (arylene ether benzonitrile), sulfonated polyimides (“SPI”s), sulfonated polystyrene, and sulfonated poly (styrene-b-isobutylene-b-styrene) (“S-SIBS”).

17. The MEA as in claim 16, wherein:
said PEM is from about 25 to about 200 μm thick.

18. A direct oxidation fuel cell (DOFC) comprising an MEA as in claim 10.

19. A direct methanol (MeOH) fuel cell (DMFC) system comprising a DOFC as in claim 18 and a source of MeOH fuel.

20. A method of fabricating a membrane electrode assembly (MEA), comprising steps of:
(a) forming a proton-conducting layer on a catalyst layer of at least one of a cathode electrode and an anode electrode; and
(b) placing a polymer electrolyte membrane (PEM) between said cathode and anode electrodes with at least one proton-conducting layer in contact with said PEM.

21. The method according to claim 20, wherein:
step (a) comprises forming a proton-conducting layer on each of said catalyst layers; and
step (b) comprises placing said PEM between said cathode and anode electrodes with said proton-conducting layers in contact with oppositely facing surfaces of said PEM.

22. The method according to claim 20, wherein:
step (a) comprises forming a proton-conducting layer comprising at least one ionomer.

23. The method according to claim 22, wherein:
step (a) comprising forming an ionomer selected from the group consisting of: fluorinated ionomers, sulfonated polystyrene ionomers, sulfonated poly (ether ketone ketone) ionomers, sulfonated polyimide ionomers, and sulfonated poly (arylene ether sulfone) ionomers.

24. The method according to claim 20, wherein:
step (b) comprises providing a PEM comprising a hydrocarbon-based polymeric material selected from the group consisting of: sulfonated poly (ether ether ketone) (“SPEEK”), sulfonated poly-(ether ether ketone ketone) (“SPEEKK”), sulfonated poly (arylene ether sulfone) (“SPES”), sulfonated poly (arylene ether benzonitrile), sulfonated polyimides (“SPI”s), sulfonated polystyrene, and sulfonated poly (styrene-b-isobutylene-b-styrene) (“S-SIBS”).
